(19) United States
(12) Patent Application Publication
(10) Pub. No.: US 2026/0247139 A1
(43) Pub. Date: Aug. 20, 2026

(54) DATA RESTORATION PROCEDURE FOR NETWORK SLICE ADMISSION CONTROL

(71) Applicant: Telefonaktiebolaget LM Ericsson (publ), Stockholm (SE)

(72) Inventor: Cheng WANG, Shanghai (CN)

(21) Appl. No.: 19/152,792

(22) PCT Filed: Jan. 15, 2024
(86) PCT No.: PCT/CN2024/072325

§ 371 Date: Jul. 31, 2025

(30) Foreign Application Priority Data
Feb. 3, 2023 (WO) PCT/CN2023/074439

(51) Int. Cl. H04W 8/30; H04W 48/16

(52) U.S. Cl. CPC H04W 8/30; H04W 48/16

(57) ABSTRACT

Methods and apparatus for NSAC data restoration procedure are provided. A method (300) in NSACF includes sending (S302), to a NSACF consumer, a NSAC data restoration notification message indicating a need for restoring NSAC data stored in the NSACF; receiving (S304), from the NSACF consumer, a NSAC data restoration request message requesting for restoring the NSAC data; and restoring (S306) the NSAC data based on the received NSAC data restoration request message.

WO

### TECHNICAL FIELD

The present disclosure relates generally to the field of communication networks, and more specifically to techniques for data restoration for Network Slice Admission Control Function (NSACF).

### BACKGROUND

3GPP defines architecture and procedure to support Network Slice Admission Control (NSAC) in TS 23.501 V 17.6.0 and TS 23.502V 17.6.0 .

The NSACF monitors and controls the number of registered UEs per network slice and/or the number of PDU Sessions per network slice for the network slices. The NSACF is configured with the maximum number of UEs and/or the maximum number of PDU Sessions allowed to be served per S-NSSAI (Single Network Slice Selection Assistance Information) subject to NSAC.

The AMF (Access and Mobility Management Function) triggers a request to NSACF for NSAC for the number of UEs per network slice when the UE's registration status for a network slice subject to NSAC is changing, i.e. during UE Registration procedure (see clause 4.2.2.2.2 of 3GPP TS 23.502V 17.6.0 ), UE Deregistration procedure (see clause 4.2.2.3 of 3GPP TS 23.502V 17.6.0 ), Network Slice-Specific Authentication and Authorisation procedure (see clause 4.2.9.2 of 3GPP TS 23.502V 17.6.0 ), AAA (Authentication, Authorization, Accounting) Server triggered Network Slice-Specific Re-authentication and Re-authorization procedure (see clause 4.2.9.3 of 3GPP TS 23.502V 17.6.0 ), AAA Server triggered Slice-Specific Authorization Revocation (see clause 4.2.9.4 of 3GPP TS 23.502 V17.6.0), and UE Configuration Update procedure for access and mobility management related parameters (see clause 4.2.4.2 of 3GPP TS 23.502V 17.6.0 ).

The AMF provides the Access Type to the NSACF when triggering a request to increase or decrease the current number of UEs registered with a S-NSSAI. The NSACF may take the Access Type into account for increasing and decreasing the number of UEs per network slice by storing the UE ID with the associated one or more Access Type(s), i.e. the NSACF is able to add or remove a registration for the UE ID for each Access Type and trigger the increase or decrease of the current number of UEs registered with a S-NSSAI based on a policy that takes the access type into account. If the Access Type provided by the AMF is not configured for NSAC in the NSACF, the NSACF always accepts the request from the AMF without increasing or decreasing the number of UEs. If the Access Type provided by the AMF is configured for NSAC in the NSACF and the maximum number is reached, the NSACF sends a reject response to the AMF including the access type.

FIG. 1 is a high level flow of NSAC showing number of UEs per network slice availability check and update procedure (also see FIG. 4.2.11.2-1 in clause 4.2.11.2 of 3GPP TS 23.502V 17.6.0 ). At step 1, the AMF triggers the Number of UEs per network slice availability check and update procedure to update the number of UEs registered with a network slice when a network slice subject to NSAC is included in the Allowed NSSAI (i.e. the AMF requests to register the UE with the S-NSSAI) or removed from the Allowed NSSAI (i.e. the AMF requests to de-register the UE from the S-NSSAI) for a UE. At step 2, the AMF sends Nnsacf_NSAC_NumOfUEsUpdate_Request message to the NSACF. The AMF includes in the message the UE ID, Access Type to which the Allowed NSSAI is applied, the S-NSSAI(s), the NF ID and the update flag which indicates whether the number of UEs registered with the S-NSSAI(s) is to be increased when the UE has gained registration to network slice(s) subject to NSAC or the number of UEs registered with the S-NSSAI(s) is to be decreased when the UE has deregistered from S-NSSAI(s) or could not renew its registration to an S-NSSAI subject to NSAC. At step 3, the NSACF determines whether the Access Type provided by the AMF is configured for the NSAC based on its configuration. If the Access Type is not configured for the NSAC, the NSACF always accepts the request from the AMF without increasing or decreasing the number of UEs. If the Access Type is configured for the NSAC, the NSACF updates the current number of UEs registered for the S-NSSAI, i.e. increases or decrease the number of UEs registered per network slice based on the information provided by the AMF in the update flag parameter. At step 4, the NSACF returns the Nnsacf_NSAC_NumOfUEsUpdate_Response message including Result indication per S-NSSAI. The Result indication includes either ‘maximum number of UEs registered with the network slice reached’ or ‘maximum number of UEs registered with the network slice not reached.’ For more information, reference may be made to clause 4.2.11.2 of 3GPP TS 23.502 V17.6.0.

The SMF (Session Management Function) anchoring PDU sessions triggers a request to NSACF for NSAC for number of PDU (Protocol Data Unit) sessions per network slice control during PDU session establishment/release procedures (see clauses 4.3.2 and 4.3.4 of 3GPP TS 23.502V 17.6.0 ).

The SMF provides the Access Type to the NSACF when triggering a request to increase or decrease the number of PDU Sessions. The NSACF takes Access Type into account for increasing and decreasing the current number of PDU Sessions depending on the applicability of the Access Type for the NSAC for maximum number of PDU Sessions for the S-NSSAI.

In case of Network Slice Admission Control and Interworking with EPC (Evolved Packet Core) is supported, the SMF+PGW-C (PDN (Packet Data Network) Gateway-Control) is configured with the information indicating which network slice is subject to NSAC. During PDN connection establishment in EPC, the SMF+PGW-C triggers interaction with NSACF to check the availability of the network slice by invoking separate NSAC procedures for number of UE and number of PDU Session (see clause 4.11.5.9 of 3GPP TS 23.502V 17.6.0 ), before the SMF+PGW-C provides the selected S-NSSAI to the UE.

FIG. 2 is a high level flow of NSAC showing number of PDU sessions per network slice availability check and update procedure (also see FIG. 4.2.11.4-1 in clause 4.2.11.4 of 3GPP TS 23.502V 17.6.0 ). At step 1, the SMF anchoring the PDU session triggers the Number of PDU Sessions per network slice availability check and update procedure for the network slices that are subject to NSAC at the beginning of a PDU Session Establishment procedure (clause 4.3.2.2.1 and clause 4.3.2.2.2 of 3GPP TS 23.502V 17.6.0 ) only for new PDU Sessions to be established and as a last step of successful PDU Session Release procedure (clause 4.3.4.2 and clause 4.3.4.3 of 3GPP TS 23.502V 17.6.0 ). At step 2, the SMF anchoring the PDU session sends Nnsacf_NSAC_NumOfPDUsUpdate_Request message to the NSACF. The SMF includes in the message the UE-ID, the PDU session ID, S-NSSAI for which the number of PDU Sessions per network slice update is required, Access Type and an update flag. At step 3, the NSACF updates the current number of PDU Sessions established on the S-NSSAI, i.e. increase or decrease the number of PDU Sessions per network slice based on the information provided by the anchor SMF in the update flag parameter. At step 4, the NSACF acknowledges the update to the anchor SMF with Nnsacf NSAC_NumOfPDUsUpdate Response message including a Result indication. If the NSACF returns a Result indication including ‘maximum number of PDU Sessions per S-NSSAI reached’, the SMF rejects the PDU Session establishment request with reject cause set to ‘maximum number of PDU Sessions per S-NSSAI reached’ and optionally a back-off timer and the Access Type. For more information, reference may be made to clause 4.2.11.4 of 3GPP TS 23.502V 17.6.0 .

### SUMMARY

The loss, corruption or inconsistency of NSAC data (e.g., the number of registered UEs, the number of established PDU sessions) stored in NSACF would impact how NSACF determines the result of NSAC. For example, crashed data of current number of registered UEs, or current number of established PDU sessions per network slice would lead to a wrong result of NSAC in the NSACF. This could seriously degrade the service offered to subscribers and impact the serviceability of network slices.

Embodiments of the present disclosure address the above and other problems by providing techniques for NSAC data restoration in the NSACF.

In some embodiments, a method in a NSACF may include: sending, to a NSACF consumer, a NSAC data restoration notification message indicating a need for restoring NSAC data stored in the NSACF; receiving, from the NSACF consumer, a NSAC data restoration request message requesting for restoring the NSAC data; and restoring the NSAC data based on the received NSAC data restoration request message.

In some other embodiments, a method in a NSACF consumer may include: receiving, from a NSACF, a NSAC data restoration notification message indicating a need for restoring NSAC data stored in the NSACF; and sending, to the NSACF, a NSAC data restoration request message requesting for restoring the NSAC data.

In some other embodiments, a NSACF may include a processor, and a memory coupled to the processor. The memory may contain instructions executable by the processor, whereby the NSACF is operative to: send, to a NSACF consumer, a NSAC data restoration notification message indicating a need for restoring NSAC data stored in the NSACF; receive, from the NSACF consumer, a NSAC data restoration request message requesting for restoring the NSAC data; and restore the NSAC data based on the received NSAC data restoration request message.

In some other embodiments, a NSACF consumer may include a processor, and a memory coupled to the processor. The memory may contain instructions executable by the processor, whereby, whereby the NSACF consumer is operative to: receive, from a NSACF, a NSAC data restoration notification message indicating a need for restoring NSAC data stored in the NSACF; and send, to the NSACF, a NSAC data restoration request message requesting for restoring the NSAC data.

In some other embodiments, a NSACF may include: a sending module for sending, to a NSACF consumer, a NSAC data restoration notification message indicating a need for restoring NSAC data stored in the NSACF; a receiving module for receiving, from the NSACF consumer, a NSAC data restoration request message requesting for restoring the NSAC data; and a restoring module for restoring the NSAC data based on the received NSAC data restoration request message.

In some other embodiments, a NSACF consumer may include: a receiving module for receiving, from a NSACF, a NSAC data restoration notification message indicating a need for restoring NSAC data stored in the NSACF; and a sending module for sending, to the NSACF, a NSAC data restoration request message requesting for restoring the NSAC data.

In some other embodiments, a non-transitory, computer-readable medium may be provided. The medium may store computer-executable instructions that, when executed by a processor of a NSACF or a NSACF consumer, cause the NSACF or the NSACF consumer to perform operations corresponding to any of the above methods.

The above solutions allow the NSACF to indicate to NSAC consumer about a need for data restoration, for example, in case of data corruption, loss or inconsistency in data stored in NSACF, and allow the NSACF consumer to send, to the NSACF, e.g., accumulated data about UE's registration/established PDU session status, so that the NSACF can restore/resynchronize the NSAC data with the received data. In this way, the NSAC data stored in the NSACF can be restored, which can mitigate the effects of failure of the NSAC data, for example, minimizing or avoiding adverse impacts on any operator's service offered to subscribers and on the serviceability of network slices.

### BRIEF DESCRIPTION OF THE DRAWINGS

These and other objects, features, and advantages of the present disclosure will become apparent upon reading the following Detailed Description in view of the Drawings briefly described below.

FIG. 1 is a high level flow of NSAC showing the number of UEs per network slice availability check and update procedure.

FIG. 2 is a high level flow of NSAC showing the number of PDU sessions per network slice availability check and update procedure.

FIG. 3 is a flowchart illustrating an exemplary method in a NSACF of a communication network (e.g., 5GC) according to various embodiments of the present disclosure.

FIG. 4 is a flowchart illustrating an exemplary method in a NSACF consumer of a communication network (e.g., 5GC) according to various embodiments of the present disclosure. FIG. 5 shows a flow of an exemplary NSAC data restoration procedure according to various embodiments of the present disclosure.

FIG. 6 is a schematic block diagram of a network node f a communication network (e.g., 5GC) according to various embodiments of the present disclosure.

FIG. 7 shows a modularized block diagram of a NSACF according to various embodiments of the present disclosure.

FIG. 8 shows a modularized block diagram of a NSACF consumer according to various embodiments of the present disclosure.

FIG. 9 shows a communication system according to various embodiments of the present disclosure.

FIG. 10 shows a UE according to various embodiments of the present disclosure.

FIG. 11 shows a network node according to various embodiments of the present disclosure.

FIG. 12 shows host computing system according to various embodiments of the present disclosure.

FIG. 13 is a block diagram of a virtualization environment in which functions implemented by some embodiments of the present disclosure may be virtualized.

FIG. 14 illustrates communication between a host computing system, a network node, and a UE via multiple connections, according to various embodiments of the present disclosure.

### DETAILED DESCRIPTION

Embodiments briefly summarized above will now be described more fully with reference to the accompanying drawings. These descriptions are provided by way of example to explain the subject matter to those skilled in the art and should not be construed as limiting the scope of the subject matter to only the embodiments described herein. More specifically, examples are provided below that illustrate the operation of various embodiments according to the advantages discussed above.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods and/or procedures disclosed herein do not have to be performed in the exact order disclosed, unless a step is explicitly described as following or preceding another step and/or where it is implicit that a step must follow or precede another step. Any feature of any of the embodiments disclosed herein can be applied to any other embodiment, wherever appropriate. Likewise, any advantage of any of the embodiments can apply to any other embodiments, and vice versa. Other objects, features and advantages of the disclosed embodiments will be apparent from the following description.

Furthermore, the following terms are used throughout the description given below:
Radio Access Node: As used herein, a “radio access node” or “radio network node” or “radio access network node” is any node in a radio access network of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit or a network node that implements a gNB Distributed Unit) or a network node that implements part of the functionality of some other type of radio access node.
Core Network Node: As used herein, a “core network node” is any type of node in a core network. Some examples of a core network node include, e.g., a Mobility Management Entity (MME), a serving gateway (SGW), a Packet Data Network Gateway (P-GW), etc. A core network node can also be a node that implements a particular core network function (NF), such as an access and mobility management function (AMF), a session management function (SMF), a user plane function (UPF), a Service Capability Exposure Function (SCEF), or the like.
Network Node: As used herein, a “network node” is any node that is part of the core network (e.g., a core network node discussed above) of a telecommunications network. Functionally, a network node is equipment capable, configured, arranged, and/or operable to communicate directly or indirectly with a wireless or wired device and/or with other network nodes or equipment in the telecommunications network, to enable and/or provide wireless or wired access to the telecommunication device, and/or to perform other functions (e.g., administration) in the telecommunications network.
Node: As used herein, the term “node” (without any prefix) can be any type of node that is capable of operating in or with a telecommunication network (including a RAN and/or a core network), including a radio access node (or equivalent term), core network node, or telecommunications device.

Note that the description given herein focuses on a 3GPP telecommunications system and, such, 3GPP terminology or terminology similar to 3GPP terminology is generally used. However, the concepts disclosed herein are not limited to a 3GPP system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from the concepts, principles, and/or embodiments described herein.

In addition, functions and/or operations described herein as being performed by a telecommunications device or a network node may be distributed over a plurality of telecommunications devices and/or network nodes.

NSACF data (e.g., the number of registered UEs, the number of established PDU sessions) per network slice is stored in NSACF and dynamically updated per NSAC request from NSACF consumers e.g. AMF, SMF or SMF+PGW. By comparing with the configured maximum number of UE and/or the maximum number of PDU Sessions, the NSACF determines the result of NSAC and sends accept or reject response to the NSACG consumers, thus controlling whether a UE is allowed to register or establish PDU sessions in a specific network slice.

The NSACF data stored in NSACF may be lost or corrupted due to different reasons (e.g. HW (Hardware) or SW (Software) fault, node restart of NSACF), which may lead to a wrong result of NSAC in the NSACF. This could seriously degrade the service offered to subscribers and impact the serviceability of network slices.

It is therefore necessary to provide a procedure to mitigate the effects of failure of NSACF data. However, such procedure is underspecified in any 3GPP standard yet.

Procedures for restoration/resynchronization of NSAC data in NSACF are provided to allow restore/resynchronize (e.g., automatically) NSAC data stored in NSACF in case any corruption or loss of the NSAC data takes place. In some embodiments, the procedures allow the NSACF to indicate to NSAC consumers (e.g. AMF, SMF) about a need for data restoration triggered by any of events of data corruption, loss or inconsistency in temporary data stored in NSACF. In some embodiments, the NSACF may potentially indicate the scope of NSAC data being impacted, which then triggers restoration actions from the NSACF consumers in a control manner. In some embodiments, the NSACF consumers may be allowed to send, to the NSACF, accumulated data about UE's registration/established PDU session status per network slice that is available in each of the NSAC consumers. Then, the NSACF may restore/resynchronize the NSAC data with the received data from the NSACF consumers. As a result, the NSAC data stored in the NSACF can be restored, which can mitigate the effects of failure of the NSAC data, for example, minimizing or avoiding adverse impacts on any operator's service offered to subscribers and on the serviceability of network slices.

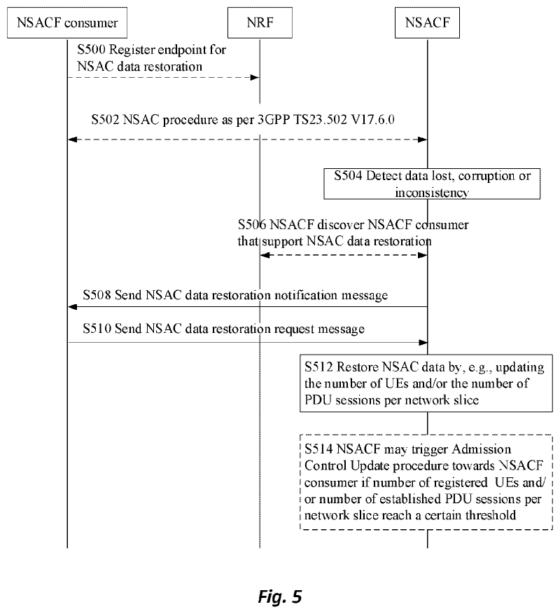

FIGS. 3 and 4 are flowcharts illustrating exemplary methods in NSACF and NSACF consumers of a communication network (e.g., 5GC) respectively, according to various embodiments of the present disclosure.

With reference to FIG. 3, the method 300 in the NSACF may include an operation of sending, to a NSACF consumer, a NSAC data restoration notification message indicating a need for restoring NSAC data stored in the NSACF (S302).

The NSAC data may include one or more of the number of registered UEs, the number of established PDU sessions, a list of UE IDs for registered UEs, a list of PDU session IDs (per UE ID) for established PDU sessions, Network Slice information (e.g., S-NSSAI), and Access Type (e.g., 3GPP Access, Non-3GPP access, or both). For example, the number of registered UEs or the number of established PDU sessions per network slice may be stored in the NSACF and dynamically updated per NSAC request from NSACF consumers (e.g. AMF, SMF or SMF+PGW).

In some embodiments, the NSAC data restoration notification message may be sent when the NSACF detects an event for triggering NSAC data restoration. The event for triggering NSAC data restoration may include one or more of occurrence of corruption, loss or inconsistency in the NSAC data, hardware and/or software fault and node restart of the NSACF. For example, when the NSACF detects data corruption, loss or inconsistency in the NSAC data (e.g., the number of UEs and the number of PDU Sessions currently registered in each network slice) stored in NSACF, or upon restart of the node, the NSACF may indicate it to its consumers in the notification message. In some embodiments, the notification message may be sent based on a local policy defined by an operator.

In some embodiments, the NSAC data stored in NSACF subject to restoration (i.e., a scope of NSAC data restoration) may be identified within the notification message. In this case, the NSACF may determine a scope of NSAC data restoration, and include one or more information elements defining the scope of NSAC data restoration in the NSAC data restoration notification message. The information elements may include one or more of:
a restoration identifier (ID) identifying NSAC data to be restored;
list of UE IDs (e.g., SUPI or GPSI) or UE ID ranges (e.g., SUPI or GPSI ranges) associated with the NSAC data to be restored;
Public Land Mobile Network (PLMN) ID associated with the NSAC data to be restored;
Data Network Name (DNN) associated with the NSAC data to be restored;
Network Slice information (e.g., S-NSSAI) associated with the NSAC data to be restored;
Serving Area information (e.g., Tracking Area Identity/Cell list) associated with the NSAC data to be restored;
NSAC Data type (e.g., number of UEs or number of PDU sessions) associated with the NSAC data to be restored;
Access Type (e.g., 3GPP Access, Non-3GPP access, or both) associated with the NSAC data to be restored;
Indicator of Evolved Packet System (EPS) interworking associated with the NSAC data to be restored, e.g., whether PDNs established in EPS should be counted for NASC;
list of PDU session IDs associated with the NSAC data to be restored;
a timer indicating a time reference for the NSAC data to be restored.

In an example, the time reference may include last time of successful NSAC data check by the NSACF and/or recovery time of the NSACF back to service. Thus the NSAC data restoration may be only needed for those NSAC data, e.g., UE's registrations or PDU establishments happen in between the last time and the recovery time.

In an example, the restoration ID may be an implementation specific identifier which indicates the scope of data associated to e.g. UE IDs (SUPIs) or a hardware or software resource that is associated with the NSAC data to be restored. The restoration ID may be provided in advance by the NSACF to the NSACF consumer and linked to data in the NSACF consumer that is associated with the NSAC data identified by the restoration ID. For example, the restoration ID is provided in a response message to a NSAC request message of a NSAC procedure that has created the identified NSAC data. The NSACF consumer may link the received restoration ID to the associated UEs, Network slices, serving area, DNN, etc. Then, when receiving the NSAC data restoration notification message from the NSACF, the NSACF consumer may determine the impacted data (e.g., UEs, PDU sessions) based on the restoration ID indicating the scope of NSAC data restoration, and send to the NSACF the determined data for restoration.

The information elements in the notification message are optional. However, by including these information elements, it is possible to narrow down the scope of the NSAC data to be restored, thus reduce signalling and processing overhead for NSAC data restoration in the communication network.

In some embodiments, the NSACF may send the NSAC data restoration notification message to the endpoint of the NSACF consumer for receiving the NSAC data restoration notification message. The endpoint may be a notification Uri or callbackUri for receiving the NSAC data restoration notification message. In an example, the endpoint of the NSACF consumer may be a predefined or default endpoint. In another example, the NSACF consumer may provide the endpoint to the NSACF, for example, in a request message of a NSAC procedure. In this case, the NSACF may create, for the NSACF consumer, a subscription on NSAC data restoration notification by using the endpoint of the NSACF consumer, so that the notification of NSAC data restoration may be automatically sent to the NSACF consumer.

In still another example, the NSACF consumer may define the endpoint for NASC data restoration in the NF profile that is registered in NRF (NF Repository Function). If no endpoint for receiving NSAC data restoration notification message is available in the NSACF, the NSACF may query the NRF to discover NSACF consumers to perform NSAC data restoration. In this case, the NSACF may query the NRF to obtain an endpoint of a NSACF consumer that supports NSACF data restoration, and then sending the NSAC data restoration notification message to the obtained endpoint of the NSACF consumer.

Referring to FIG. 3, the method 300 may further include an operation of receiving, from the NSACF consumer, a NSAC data restoration request message requesting for restoring the NSAC data (S304), and an operation of restoring the NSAC data based on the received NSAC data restoration request message (S306).

In some embodiments, the NSAC data restoration request message may include one or more information elements for the NSAC data restoration corresponding to the scope of NSAC data restoration defined in the NSAC data restoration notification message. The information elements for the NSAC data restoration may include one or more of a list of UE IDs associated with the NSAC data to be restored, Network Slice information associated with the NSAC data to be restored, Access Type associated with the NSAC data to be restored, and a list of PDU session IDs associated with the NSAC data to be restored. The NSACF may restore the NSAC data by updating the NSAC data (e.g., the current number of UEs registered or the current number of PDU Sessions established) stored in the NSACF based on the information elements for the NSAC data restoration included in the NSAC data restoration request message.

In some embodiments, the NSAC data restoration request message may include a restoration flag indicating that the NSAC data restoration request message is sent due to the NSAC data restoration. The restoration flag may be also referred to as “nsacRestInd” flag. In an example, based on the restoration flag, the NSACF may restore the NSAC data by overwriting the NSAC data stored in the NSACF with data indicated in the NSAC data restoration request message, and/or creating new NSAC data if there is no NSAC data stored in the NSACF corresponding to data indicated in the NSAC data restoration request message. In another example, based on the restoration flag, the NSACF may prioritize the restoring of the NSAC data over any other NSAC procedure, for example, by locking the normal NSAC procedures.

Now with reference to FIG. 4, the method 400 in a NSACF consumer may include an operation of receiving, from a NSACF, a NSAC data restoration notification message indicating a need for restoring NSAC data stored in the NSACF (S402), and an operation of sending, to the NSACF, a NSAC data restoration request message requesting for restoring the NSAC data (S404).

In some embodiments, before the operation S404, the NSACF consumer may determine a scope of NSAC data restoration based on the received NSAC data restoration notification message. In an example, when the restoration ID described above is included in the received NSAC data restoration notification message from the NSACF, the NSACF consumer may determine the impacted data (e.g., UEs, PDU sessions) based on the restoration ID. As described above, the restoration ID has been received in advance by the NSACF consumer from the NSACF, for example in a response message to a NSAC request message of a NSAC procedure that has created the identified NSAC data, and has been linked to data in the NSACF consumer that is associated with the NSAC data identified by the restoration ID.

Then, the NSACF consumer may include one or more information elements corresponding to the scope of NSAC data restoration in the NSAC data restoration request message, and sent such restoration request message to the NSACF. The information elements may include one or more of a list of UE IDs, Network Slice information, Access Type and a list of PDU session IDs associated with the NSAC data to be restored.

In some embodiments, the NSAC data restoration request message may be a message similar to the existing message for NSAC. In an example, when the NSACF consumer is AMF, the NSAC data restoration request message may be similar to the Nnsacf NSAC_NumOfUEsUpdate_Request message, and include a list of impacted UE IDs, the impacted Access Types, the list of S-NSSAI(s), and an update flag which indicates the number of UEs registered with the S-NSSAI(s) is to be increased. In another example, when the NSACF consumer is SMF, the NSAC data restoration request message may be similar to the Nnsacf_NSAC_NumOfPDUsUpdate_Request message, and include a list of impacted UE IDs, a list of impacted PDU session IDs, the list of S-NSSAIs, Access Types and a update flag which indicates that the number of PDUs established on the S-NSSAI is to be increased. Upon receiving the NSAC data restoration request message from the AMF or SMF, the NSACF may update the current number of UEs registered for the S-NSSAIs or the current number of PDU Sessions established on the S-NSSAI based on the information elements included in the received restoration request message.

In some embodiments, the NSAC data restoration request message may be of a new message type for NSAC data restoration for one or plural of impacts UEs or PDU sessions. In an example, the NSACF consumers may include a restoration flag (“nsacRestInd”) in the NSAC data restoration request message indicating that the request message is sent due to the NSAC data restoration. Based on the restoration flag, the NSACF may restore the NSAC data by overwriting the NSAC data stored in the NSACF with data indicated in the NSAC data restoration request message, and/or creating new NSAC data if there is no NSAC data stored in the NSACF corresponding to data indicated in the NSAC data restoration request message. Further, based on the restoration flag, the NSACF may prioritize the restoring of the NSAC data over any other NSAC procedure, for example, by locking the normal NSAC procedures.

In some embodiments, the NSACF consumer may provide its endpoint (e.g., callbackUri) for receiving the NSAC data restoration notification message to the NSACF, for example, in a request message of a NSAC procedure. In this case, at the operation S402, the NSACF consumer may receive the NSAC data restoration notification message at the provided endpoint.

In some embodiments, the NSACF consumer may define the endpoint for NASC data restoration in the NF profile that is registered in the NRF. The NSACF may query the NRF to obtain the endpoint of the NSACF consumer that supports NSACF data restoration. In this case, at the operation S402, the NSACF consumer may receive the NSAC data restoration notification message at the registered endpoint.

So far, the methods in the NSACF and the NSACF consumer for NSAC data restoration have been described. In the following, an example flow of NSAC data restoration procedure according to various embodiments of the present disclosure will be described in connection with FIG. 5.

As shown in FIG. 5, at S500 the NSACF consumer (e.g. AMF, SMF, or SMF+PGW) may define an endpoint (e.g., callbackUri) for NASC data restoration in the NF profile that is registered in the NRF.

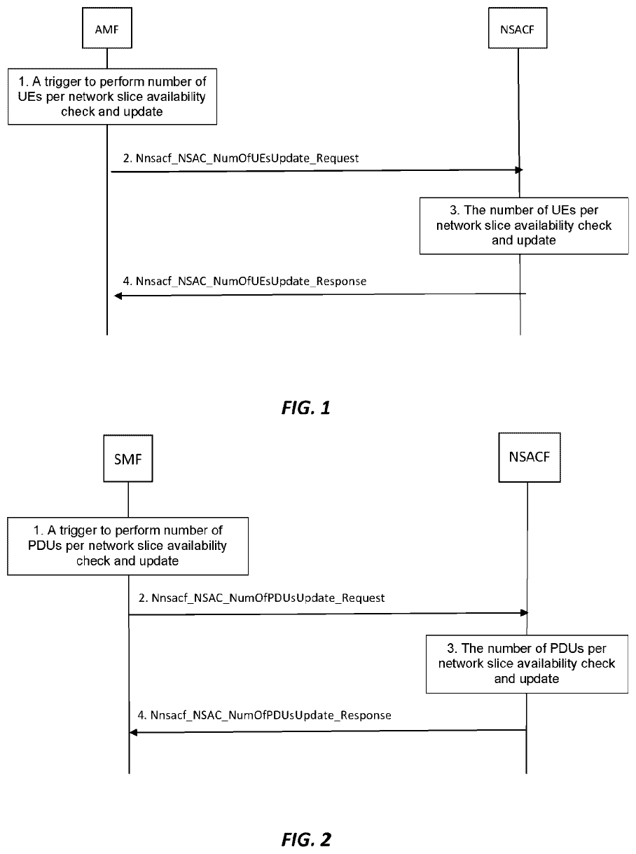

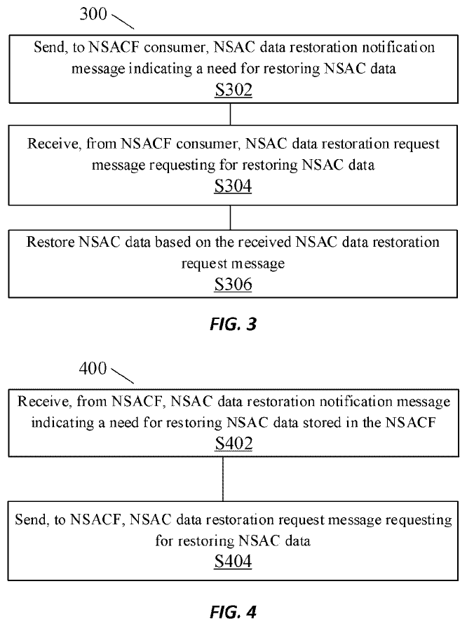

At S502, the NSACF consumer and the NSACF may perform a NSAC procedure for number of UEs and/or number of PDU Sessions per network slice as defined in 3GPP TS23.502 V17.6.0 and as described above with reference to FIGS. 1 and 2. The NSACF may store the NASC data and the received identity of the NSACF consumers.

At this time, the NSACF consumer may provide an endpoint (e.g., callbackUri) for NASC data restoration in the request message of NSAC procedure. The NSACF may create for the NSACF consumer a subscription on NSAC data restoration notification by using the endpoint of the NSACF consumer.

Further, during the NSAC procedure, the NSACF may provide to the NSACF consumer a restoration ID for the NSAC data stored in the NSACF in the response message of the NSAC procedure. The NSACF consumer may link the received restoration ID to data stored therein, for example, the associated UEs, PDUs, Access Type, Network Slice information, Serving Area information, DNN, PLMN ID, Indicator of EPS interworking etc.

At S504, the NSACF may detect corruption, loss or inconsistency in the NSAC data caused due to certain scenarios (e.g. HW/SW failure, node restart of the NSACF, administration command), and thus NSAC data restoration needs to be performed. The NSACF may determine a scope of NSAC data restoration and include one or more information elements indicating the scope of NSAC data restoration in the NSAC data restoration notification which is to be sent to the NSACF consumer.

At S506, if the endpoint of the NSACF for receiving the NSAC data restoration notification message is not available in the NSACF, the NSACF may query the NRF and discover a NSACF consumer and its endpoint to perform NSAC data restoration.

At S508, the NSACF may send the NSAC data restoration notification message to the endpoint of the NSACF consumer, as provided at S502 or discovered at S503, to notify potential NSAC data corrupt, loss or inconsistency and the need for NSAC data restoration. The NSAC data restoration notification message may contain the above-described information elements for the scope of NSAC data restoration, e.g. the restoration ID, list of UE IDs, list of PDU session IDs, the network slices (S-NSSAIs) information, Access types, Serving Area information, etc.

At S510, upon receiving the NSAC data restoration notification message, the NSACF consumer may determine, for example, the impacted UEs/PDU sessions based on the scope of NSAC data restoration, and send to the NSACF the NSAC data restoration request message including one or more information elements indicating the determined data to be used for NSAC data restoration.

For the NSAC data restoration request message, the NSACF consumer may use a message type similar to the existing message for the conventional NSAC procedure with respect to one or plural of impacts UEs or PDU sessions. In an example, the NSACF consumer is AMF, and it sends to the NSACF a NSAC data restoration request message similar to the Nnsacf NSAC_NumOfUEsUpdate_Request message. The AMF may include in the restoration request message, for example, a list of impacted UE IDs, the impacted Access Types, the list of S-NSSAI(s), and an update flag which indicates the number of UEs registered with the S-NSSAI(s) is to be increased. In another example, the NSACF consumer is SMF, and it sends to the NSACF a NSAC data restoration request message similar to the Nnsacf NSAC_NumOfPDUsUpdate_Request message. The SMF may include in the restoration request message, for example, a list of impacted UE-ID, the PDU session IDs, the list of S-NSSAIs, Access Types and an update flag which indicates that the number of PDUs established on the S-NSSAI is to be increased.

For the NSAC data restoration request message, the NSACF consumer may use a new message type for NSAC data restoration with respect to one or plural of impacts UEs or PDU sessions. In an example, the NSACF consumer may include a restoration flag (“nsacRestInd”) in the restoration request message to indicate that the restoration request message is due to NSAC data restoration.

At S512, the NSACF may update/resynchronize the current number of UEs registered for the S-NSSAIs or the current number of PDU Sessions established on the S-NSSAI based on the received NSAC data restoration request message.

If the NSAC data restoration request message includes the restoration flag, based on the received restoration flag, the NSACF may overwrite the existing NSAC data stored locally or create one if not available. Further, based on the restoration flag, the NSACF may prioritize the NSAC data restoration procedure over any normal NSAC procedure, e.g., by locking the latter one.

At S514, after completing the NSAC data restoration procedure, the NSACF may trigger an Admission Control Update procedure, as described above with reference to FIGS. 1 and 2, towards the NSACF consumer if the number of registered UEs and/or the number of established PDU sessions per network slice updated from the NASC data restoration procedure reach a certain threshold.

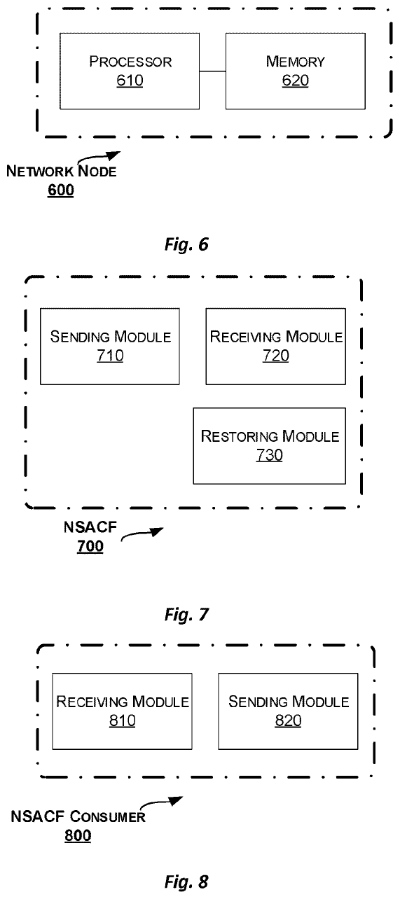

FIG. 6 is a schematic block diagram of a network node f a communication network (e.g., 5GC) according to various embodiments of the present disclosure. The network node 600 includes a processor 610 and a memory 620 coupled to the processor 610. The memory 620 may contain instructions executable by the processor 610 whereby the network node 600 is operative to, when implementing a NSACF, perform the operations, e.g., of the procedure described earlier in conjunction with FIG. 3. Particularly, the memory 620 may contain instructions executable by the processor 610 whereby the network node 600 implementing a NSACF is operative to send, to a NSACF consumer, a NSAC data restoration notification message indicating a need for restoring NSAC data stored in the NSACF, receive, from the NSACF consumer, a NSAC data restoration request message requesting for restoring the NSAC data, and restore the NSAC data based on the received NSAC data restoration request message.

In some embodiments, the memory 620 may further contain instructions executable by the processor 610 whereby the network node 600 implementing the NSACF is operative to determine a scope of NSAC data restoration and include one or more information elements defining the scope of NSAC data restoration in the NSAC data restoration notification message.

In some embodiments, the memory 620 may further contain instructions executable by the processor 610 whereby the network node 600 implementing the NSACF is operative to query a NF Repository Function (NRF) to obtain an endpoint of a NSACF consumer, that supports NSACF data restoration, for receiving the NSAC data restoration notification message, and send the NSAC data restoration notification message to the obtained endpoint of the NSACF consumer.

In some embodiments, the memory 620 may further contain instructions executable by the processor 610 whereby the network node 600 implementing the NSACF is operative to restore the NSAC data by updating the NSAC data stored in the NSACF based on one or more information elements for the NSAC data restoration included in the NSAC data restoration request message.

In some embodiments, the memory 620 may further contain instructions executable by the processor 610 whereby the network node 600 implementing the NSACF is operative to restore the NSAC data by overwriting the NSAC data stored in the NSACF with data indicated in the NSAC data restoration request message, or creating new NSAC data if there is no NSAC data stored in the NSACF corresponding to data indicated in the NSAC data restoration request message, when the NSAC data restoration request message includes a restoration flag indicating that the NSAC data restoration request message is sent due to the NSAC data restoration.

In some embodiments, the memory 620 may further contain instructions executable by the processor 610 whereby the network node 600 implementing the NSACF is operative to, based on the restoration flag, prioritize the restoring of the NSAC data over any other NSAC procedure.

Alternatively, the memory 620 may contain instructions executable by the processor 610 whereby the network node 600 is operative to, when implementing a NSACF consumer, perform the operations, e.g., of the procedure described earlier in conjunction with FIG. 4. Particularly, the memory 620 may contain instructions executable by the processor 610 whereby the network node 600 implementing a NSACF consumer is operative to receive, from a NSACF, a NSAC data restoration notification message indicating a need for restoring NSAC data stored in the NSACF, and send, to the NSACF, a NSAC data restoration request message requesting for restoring the NSAC data.

In some embodiments, the memory 620 may further contain instructions executable by the processor 610 whereby the network node 600 implementing the NSACF consumer is operative to determine a scope of NSAC data restoration based on the received NSAC data restoration notification message, and include one or more information elements corresponding to the scope of NSAC data restoration in the NSAC data restoration request message.

In some embodiments, the memory 620 may further contain instructions executable by the processor 610 whereby the network node 600 implementing the NSACF consumer is operative to include, in the NSAC data restoration request message, a restoration flag indicating that the NSAC data restoration request message is sent due to the NSAC data restoration.

In some embodiments, the memory 620 may further contain instructions executable by the processor 610 whereby the network node 600 implementing the NSACF consumer is operative to, if the NSAC data restoration notification message includes a restoration ID identifying the NSAC data to be restored, determine data in the NSACF consumer that is linked to the restoration ID included in the NSAC data restoration notification message, and include one or more information elements indicating the determined data in the NSAC data restoration request message.

In some embodiments, the memory 620 may further contain instructions executable by the processor 610 whereby the network node 600 implementing the NSACF consumer is operative to provide an endpoint for receiving the NSAC data restoration notification message to the NSACF, or register, in a NRF, an endpoint of the NSACF consumer for receiving the NSAC data restoration notification message.

The processor 610 may be a single CPU (Central Processing Unit), but could also comprise two or more processing units. For example, the processor may include general purpose microprocessors; instruction set processors and/or related chips sets and/or special purpose microprocessors such as Application Specific Integrated Circuits (ASICs). The processor may also comprise board memory for caching purposes.

The present disclosure also provides at least one computer program product in the form of a non-volatile or volatile memory, e.g., a non-transitory computer-readable storage medium, an Electrically Erasable Programmable Read-Only Memory (EEPROM), a flash memory and a hard drive. The computer program product includes a computer program. The computer program includes: code/computer-readable instructions, which when executed by the processor 610 causes the network node 600 to perform the operations, e.g., of the procedures described earlier in conjunction with FIGS. 3 to 5.

FIG. 7 shows a modularized block diagram of a NSACF according to various embodiments of the present disclosure. The NSACF 700 may be configured to perform the method 300 as described above in connection with FIG. 3. As shown in FIG. 7, the NSACF 700 may include: a send module 710 for sending, to a NSACF consumer, a NSAC data restoration notification message indicating a need for restoring NSAC data stored in the NSACF; a receiving module 720 for receiving, from the NSACF consumer, a NSAC data restoration request message requesting for restoring the NSAC data; and a restoring module 730 for restoring the NSAC data based on the received NSAC data restoration request message.

FIG. 8 shows a modularized block diagram of a NSACF consumer according to various embodiments of the present disclosure. The NSACF consumer 800 may be configured to perform the method 400 as described above in connection with FIG. 4. As shown in FIG. 8, the NSACF consumer 800 may include: a receiving module 810 for receiving, from a NSACF, a NSAC data restoration notification message indicating a need for restoring NSAC data stored in the NSACF; and a sending module 820 for sending to the NSACF, a NSAC data restoration request message requesting for restoring the NSAC data.

The above modules 710, 720, 730, 810 and/or 820 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the operations described above and illustrated, e.g., in FIGS. 3 to 5.

Although various embodiments are described herein above in terms of methods, apparatus, devices, computer-readable medium and receivers, the person of ordinary skill will readily comprehend that such methods can be embodied by various combinations of hardware and software in various systems, communication devices, computing devices, control devices, apparatuses, non-transitory computer-readable media, etc.

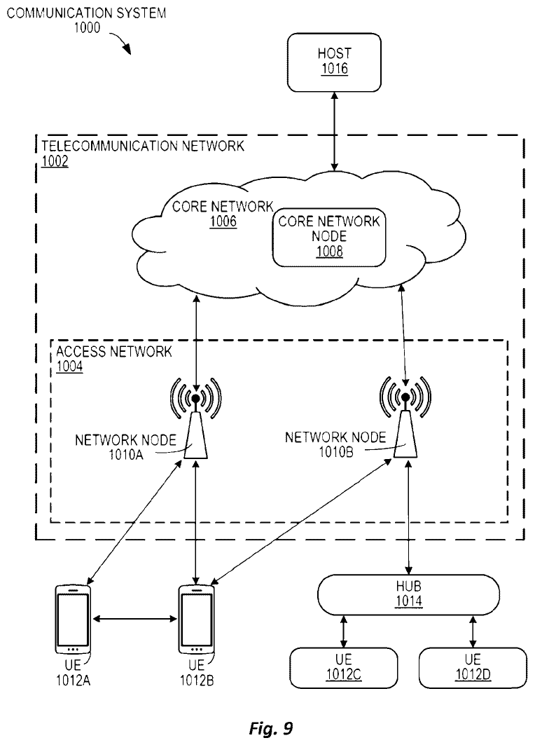

FIG. 9 shows an example of a communication system 1000 in accordance with some embodiments. The concept of the present disclosure may be applied in the communication system 1000. In this example, the communication system 1000 includes a telecommunication network 1002 that includes an access network 1004, such as a radio access network (RAN), and a core network 1006, which includes one or more core network nodes 1008. The access network 1004 includes one or more access network nodes, such as network nodes 1010a and 1010b (one or more of which may be generally referred to as network nodes 1010), or any other similar 3rd Generation Partnership Project (3GPP) access node or non-3GPP access point. The network nodes 1010 facilitate direct or indirect connection of user equipment (UE), such as by connecting UEs 1012a, 1012b, 1012c, and 1012d (one or more of which may be generally referred to as UEs 1012) to the core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes, UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The UEs 1012 may be any of a wide variety of communication devices, including wireless devices arranged, configured, and/or operable to communicate wirelessly with the network nodes 1010 and other communication devices. Similarly, the network nodes 1010 are arranged, capable, configured, and/or operable to communicate directly or indirectly with the UEs 1012 and/or with other network nodes or equipment in the telecommunication network 1002 to enable and/or provide network access, such as wireless network access, and/or to perform other functions, such as administration in the telecommunication network 1002.

In the depicted example, the core network 1006 connects the network nodes 1010 to one or more hosts, such as host 1016. These connections may be direct or indirect via one or more intermediary networks or devices. In other examples, network nodes may be directly coupled to hosts. The core network 1006 includes one more core network nodes (e.g., core network node 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF). The SMF and AMF as well as methods in them according to various embodiments of the present disclosure may be implemented in the core network nodes.

The host 1016 may be under the ownership or control of a service provider other than an operator or provider of the access network 1004 and/or the telecommunication network 1002, and may be operated by the service provider or on behalf of the service provider. The host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

In various embodiments, core network node 1008 can implement network function (NF) of communication system or network 900. In other words, the NF may be located in the core network 1006 or coupled to the core network 1006. Such a NF can be configured to perform operations corresponding to exemplary methods described above.

As a whole, the communication system 1000 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1002 is a cellular network that implements 3GPP standardized features. Accordingly, the telecommunications network 1002 may support network slicing to provide different logical networks to different devices that are connected to the telecommunication network 1002. For example, the telecommunications network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single-or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 1014 communicates with the access network 1004 to facilitate indirect communication between one or more UEs (e.g., UE 1012c and/or 1012d) and network nodes (e.g., network node 1010b). In some examples, the hub 1014 may be a controller, router, content source and analytics, or any of the other communication devices described herein regarding UEs. For example, the hub 1014 may be a broadband router enabling access to the core network 1006 for the UEs. As another example, the hub 1014 may be a controller that sends commands or instructions to one or more actuators in the UEs. Commands or instructions may be received from the UEs, network nodes 1010, or by executable code, script, process, or other instructions in the hub 1014. As another example, the hub 1014 may be a data collector that acts as temporary storage for UE data and, in some embodiments, may perform analysis or other processing of the data. As another example, the hub 1014 may be a content source. For example, for a UE that is a VR headset, display, loudspeaker or other media delivery device, the hub 1014 may retrieve VR assets, video, audio, or other media or data related to sensory information via a network node, which the hub 1014 then provides to the UE either directly, after performing local processing, and/or after adding additional local content. In still another example, the hub 1014 acts as a proxy server or orchestrator for the UEs, in particular in if one or more of the UEs are low energy IoT devices.

The hub 1014 may have a constant/persistent or intermittent connection to the network node 1010b. The hub 1014 may also allow for a different communication scheme and/or schedule between the hub 1014 and UEs (e.g., UE 1012c and/or 1012d), and between the hub 1014 and the core network 1006. In other examples, the hub 1014 is connected to the core network 1006 and/or one or more UEs via a wired connection. Moreover, the hub 1014 may be configured to connect to an M2M service provider over the access network 1004 and/or to another UE over a direct connection. In some scenarios, UEs may establish a wireless connection with the network nodes 1010 while still connected via the hub 1014 via a wired or wireless connection. In some embodiments, the hub 1014 may be a dedicated hub-that is, a hub whose primary function is to route communications to/from the UEs from/to the network node 1010b. In other embodiments, the hub 1014 may be a non-dedicated hub-that is, a device which is capable of operating to route communications between the UEs and network node 1010b, but which is additionally capable of operating as a communication start and/or end point for certain data channels.

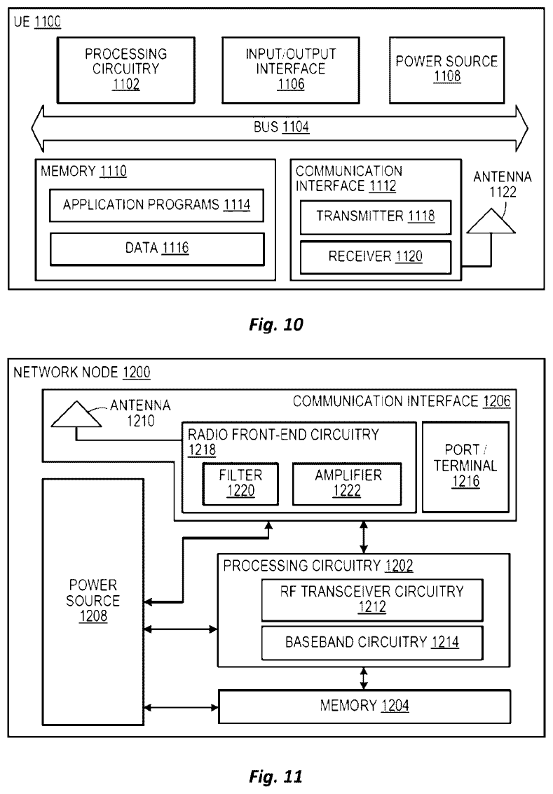

FIG. 10 shows a UE 1100 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IOT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1100 includes processing circuitry 1102 that is operatively coupled via a bus 1104 to an input/output interface 1106, a power source 1108, a memory 1110, a communication interface 1112, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

The processing circuitry 1102 is configured to process instructions and data and may be configured to implement any sequential state machine operative to execute instructions stored as machine-readable computer programs in the memory 1110. The processing circuitry 1102 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1102 may include multiple central processing units (CPUs).

In the example, the input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1108 is structured as a battery or battery pack. Other types of power sources, such as an external power source (e.g., an electricity outlet), photovoltaic device, or power cell, may be used. The power source 1108 may further include power circuitry for delivering power from the power source 1108 itself, and/or an external power source, to the various parts of the UE 1100 via input circuitry or an interface such as an electrical power cable. Delivering power may be, for example, for charging of the power source 1108. Power circuitry may perform any formatting, converting, or other modification to the power from the power source 1108 to make the power suitable for the respective components of the UE 1100 to which power is supplied.

The memory 1110 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1110 includes one or more application programs 1114, such as an operating system, web browser application, a widget, gadget engine, or other application, and corresponding data 1116. The memory 1110 may store, for use by the UE 1100, any of a variety of various operating systems or combinations of operating systems.

The memory 1110 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1110 may allow the UE 1100 to access instructions, application programs and the like, stored on transitory or non-transitory memory media, to off-load data, or to upload data. An article of manufacture, such as one utilizing a communication system may be tangibly embodied as or in the memory 1110, which may be or comprise a device-readable storage medium.

The processing circuitry 1102 may be configured to communicate with an access network or other network using the communication interface 1112. The communication interface 1112 may comprise one or more communication subsystems and may include or be communicatively coupled to an antenna 1122. The communication interface 1112 may include one or more transceivers used to communicate, such as by communicating with one or more remote transceivers of another device capable of wireless communication (e.g., another UE or a network node in an access network). Each transceiver may include a transmitter 1118 and/or a receiver 1120 appropriate to provide network communications (e.g., optical, electrical, frequency allocations, and so forth). Moreover, the transmitter 1118 and receiver 1120 may be coupled to one or more antennas (e.g., antenna 1122) and may share circuit components, software or firmware, or alternatively be implemented separately.

In the illustrated embodiment, communication functions of the communication interface 1112 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1112, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IOT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1100 shown in FIG. 10.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IOT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 11 shows a network node 1200 in accordance with some embodiments. The RAN node of the present disclosure may be implemented with the network node 1200. The network node may refer to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1200 includes a processing circuitry 1202, a memory 1204, a communication interface 1206, and a power source 1208. The network node 1200 may be composed of multiple physically separate components (e.g., a NodeB component and a RNC component, or a BTS component and a BSC component, etc.), which may each have their own respective components. In certain scenarios in which the network node 1200 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1200 may be configured to support multiple radio access technologies (RATs). In such embodiments, some components may be duplicated (e.g., separate memory 1204 for different RATs) and some components may be reused (e.g., a same antenna 1210 may be shared by different RATs). The network node 1200 may also include multiple sets of the various illustrated components for different wireless technologies integrated into network node 1200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1200.

The processing circuitry 1202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1200 components, such as the memory 1204, to provide network node 1200 functionality.

In some embodiments, the processing circuitry 1202 includes a system on a chip (SOC). In some embodiments, the processing circuitry 1202 includes one or more of radio frequency (RF) transceiver circuitry 1212 and baseband processing circuitry 1214. In some embodiments, the radio frequency (RF) transceiver circuitry 1212 and the baseband processing circuitry 1214 may be on separate chips (or sets of chips), boards, or units, such as radio units and digital units. In alternative embodiments, part or all of RF transceiver circuitry 1212 and baseband processing circuitry 1214 may be on the same chip or set of chips, boards, or units.

The memory 1204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1202. The memory 1204 may store any suitable instructions, data, or information, including a computer program, software, an application including one or more of logic, rules, code, tables, and/or other instructions capable of being executed by the processing circuitry 1202 and utilized by the network node 1200. The memory 1204 may be used to store any calculations made by the processing circuitry 1202 and/or any data received via the communication interface 1206. In some embodiments, the processing circuitry 1202 and memory 1204 is integrated.

The communication interface 1206 is used in wired or wireless communication of signaling and/or data between a network node, access network, and/or UE. As illustrated, the communication interface 1206 comprises port(s)/terminal(s) 1216 to send and receive data, for example to and from a network over a wired connection. The communication interface 1206 also includes radio front-end circuitry 1218 that may be coupled to, or in certain embodiments a part of, the antenna 1210. Radio front-end circuitry 1218 comprises filters 1220 and amplifiers 1222. The radio front-end circuitry 1218 may be connected to an antenna 1210 and processing circuitry 1202. The radio front-end circuitry may be configured to condition signals communicated between antenna 1210 and processing circuitry 1202. The radio front-end circuitry 1218 may receive digital data that is to be sent out to other network nodes or UEs via a wireless connection. The radio front-end circuitry 1218 may convert the digital data into a radio signal having the appropriate channel and bandwidth parameters using a combination of filters 1220 and/or amplifiers 1222. The radio signal may then be transmitted via the antenna 1210. Similarly, when receiving data, the antenna 1210 may collect radio signals which are then converted into digital data by the radio front-end circuitry 1218. The digital data may be passed to the processing circuitry 1202. In other embodiments, the communication interface may comprise different components and/or different combinations of components.

In certain alternative embodiments, the network node 1200 does not include separate radio front-end circuitry 1218, instead, the processing circuitry 1202 includes radio front-end circuitry and is connected to the antenna 1210. Similarly, in some embodiments, all or some of the RF transceiver circuitry 1212 is part of the communication interface 1206. In still other embodiments, the communication interface 1206 includes one or more ports or terminals 1216, the radio front-end circuitry 1218, and the RF transceiver circuitry 1212, as part of a radio unit (not shown), and the communication interface 1206 communicates with the baseband processing circuitry 1214, which is part of a digital unit (not shown).

The antenna 1210 may include one or more antennas, or antenna arrays, configured to send and/or receive wireless signals. The antenna 1210 may be coupled to the radio front-end circuitry 1218 and may be any type of antenna capable of transmitting and receiving data and/or signals wirelessly. In certain embodiments, the antenna 1210 is separate from the network node 1200 and connectable to the network node 1200 through an interface or port.

The antenna 1210, communication interface 1206, and/or the processing circuitry 1202 may be configured to perform any receiving operations and/or certain obtaining operations described herein as being performed by the network node. Any information, data and/or signals may be received from a UE, another network node and/or any other network equipment. Similarly, the antenna 1210, the communication interface 1206, and/or the processing circuitry 1202 may be configured to perform any transmitting operations described herein as being performed by the network node. Any information, data and/or signals may be transmitted to a UE, another network node and/or any other network equipment.

The power source 1208 provides power to the various components of network node 1200 in a form suitable for the respective components (e.g., at a voltage and current level needed for each respective component). The power source 1208 may further comprise, or be coupled to, power management circuitry to supply the components of the network node 1200 with power for performing the functionality described herein. For example, the network node 1200 may be connectable to an external power source (e.g., the power grid, an electricity outlet) via an input circuitry or interface such as an electrical cable, whereby the external power source supplies power to power circuitry of the power source 1208. As a further example, the power source 1208 may comprise a source of power in the form of a battery or battery pack which is connected to, or integrated in, power circuitry. The battery may provide backup power should the external power source fail.

Embodiments of the network node 1200 may include additional components beyond those shown in FIG. 11 for providing certain aspects of the network node's functionality, including any of the functionality described herein and/or any functionality necessary to support the subject matter described herein. For example, the network node 1200 may include user interface equipment to allow input of information into the network node 1200 and to allow output of information from the network node 1200. This may allow a user to perform diagnostic, maintenance, repair, and other administrative functions for the network node 1200.

In various embodiments, network node 1200 can be configured to perform operations performed by network nodes, network functions (NFs), and application functions (AFs) in exemplary methods or procedures described above.

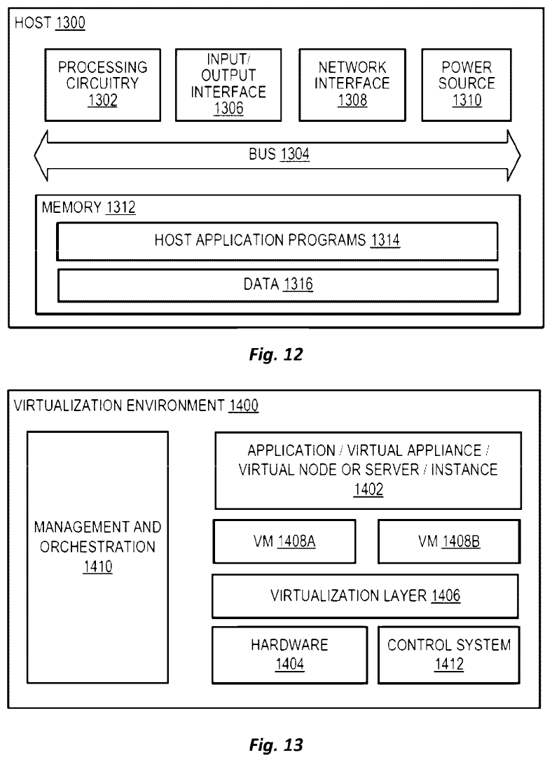

FIG. 12 is a block diagram of a host 1300, which may be an embodiment of the host 1016 of FIG. 9, in accordance with various aspects described herein. As used herein, the host 1300 may be or comprise various combinations hardware and/or software, including a standalone server, a blade server, a cloud-implemented server, a distributed server, a virtual machine, container, or processing resources in a server farm. The host 1300 may provide one or more services to one or more UEs.

The host 1300 includes processing circuitry 1302 that is operatively coupled via a bus 1304 to an input/output interface 1306, a network interface 1308, a power source 1310, and a memory 1312. Other components may be included in other embodiments. Features of these components may be substantially similar to those described with respect to the devices of previous figures, such as FIGS. 11 and 12, such that the descriptions thereof are generally applicable to the corresponding components of host 1300.

The memory 1312 may include one or more computer programs including one or more host application programs 1314 and data 1316, which may include user data, e.g., data generated by a UE for the host 1300 or data generated by the host 1300 for a UE. Embodiments of the host 1300 may utilize only a subset or all of the components shown. The host application programs 1314 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1314 may also provide for user authentication and licensing checks and may periodically report health, routes, and content availability to a central node, such as a device in or on the edge of a core network. Accordingly, the host 1300 may select and/or indicate a different host for over-the-top services for a UE. The host application programs 1314 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 13 is a block diagram illustrating a virtualization environment 1400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1402 (which may alternatively be called software instances, virtual appliances, network functions, virtual nodes, virtual network functions, etc.) are run in the virtualization environment 1400 to implement some of the features, functions, and/or benefits of some of the embodiments disclosed herein.

Hardware 1404 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1406 (also referred to as hypervisors or virtual machine monitors (VMMs)), provide VMs 1408a and 1408b (one or more of which may be generally referred to as VMs 1408), and/or perform any of the functions, features and/or benefits described in relation with some embodiments described herein. The virtualization layer 1406 may present a virtual operating platform that appears like networking hardware to the VMs 1408.

The VMs 1408 comprise virtual processing, virtual memory, virtual networking or interface and virtual storage, and may be run by a corresponding virtualization layer 1406. Different embodiments of the instance of a virtual appliance 1402 may be implemented on one or more of VMs 1408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1408 may be a software implementation of a physical machine that runs programs as if they were executing on a physical, non-virtualized machine. Each of the VMs 1408, and that part of hardware 1404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1408 on top of the hardware 1404 and corresponds to the application 1402.

Hardware 1404 may be implemented in a standalone network node with generic or specific components. Hardware 1404 may implement some functions via virtualization. Alternatively, hardware 1404 may be part of a larger cluster of hardware (e.g., such as in a data center or CPE) where many hardware nodes work together and are managed via management and orchestration 1410, which, among others, oversees lifecycle management of applications 1402. In some embodiments, hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1412 which may alternatively be used for communication between hardware nodes and radio units.

In various embodiments, virtualization environment 1400 can be configured to host various network functions (NFs) and application functions (AFs) described above. In other words, these NFs and AFs can be implemented in respective virtual nodes 1402 based on underlying hardware 1404. These respective virtual nodes 1402 can be configured to perform various exemplary methods or procedures described above.

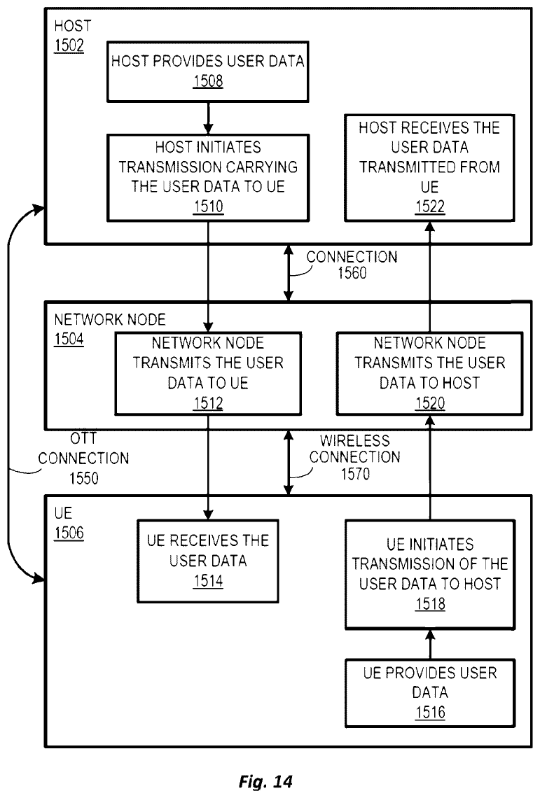

FIG. 14 shows a communication diagram of a host 1502 communicating via a network node 1504 with a UE 1506 over a partially wireless connection in accordance with some embodiments. Example implementations, in accordance with various embodiments, of the UE (such as a UE 1012a of FIG. 9 and/or UE 1100 of FIG. 10), network node (such as network node 1010a of FIG. 9 and/or network node 1200 of FIG. 11), and host (such as host 1016 of FIG. 9 and/or host 1300 of FIG. 12) discussed in the preceding paragraphs will now be described with reference to FIG. 14.

Like host 1300, embodiments of host 1502 include hardware, such as a communication interface, processing circuitry, and memory. The host 1502 also includes software, which is stored in or accessible by the host 1502 and executable by the processing circuitry. The software includes a host application that may be operable to provide a service to a remote user, such as the UE 1506 connecting via an over-the-top (OTT) connection 1550 extending between the UE 1506 and host 1502. In providing the service to the remote user, a host application may provide user data which is transmitted using the OTT connection 1550.

The network node 1504 includes hardware enabling it to communicate with the host 1502 and UE 1506. The connection 1560 may be direct or pass through a core network (like core network 1006 of FIG. 9) and/or one or more other intermediate networks, such as one or more public, private, or hosted networks. For example, an intermediate network may be a backbone network or the Internet.

The UE 1506 includes hardware and software, which is stored in or accessible by UE 1506 and executable by the UE's processing circuitry. The software includes a client application, such as a web browser or operator-specific “app” that may be operable to provide a service to a human or non-human user via UE 1506 with the support of the host 1502. In the host 1502, an executing host application may communicate with the executing client application via the OTT connection 1550 terminating at the UE 1506 and host 1502. In providing the service to the user, the UE's client application may receive request data from the host's host application and provide user data in response to the request data. The OTT connection 1550 may transfer both the request data and the user data. The UE's client application may interact with the user to generate the user data that it provides to the host application through the OTT connection 1550.

The OTT connection 1550 may extend via a connection 1560 between the host 1502 and the network node 1504 and via a wireless connection 1570 between the network node 1504 and the UE 1506 to provide the connection between the host 1502 and the UE 1506. The connection 1560 and wireless connection 1570, over which the OTT connection 1550 may be provided, have been drawn abstractly to illustrate the communication between the host 1502 and the UE 1506 via the network node 1504, without explicit reference to any intermediary devices and the precise routing of messages via these devices.

As an example of transmitting data via the OTT connection 1550, in step 1508, the host 1502 provides user data, which may be performed by executing a host application. In some embodiments, the user data is associated with a particular human user interacting with the UE 1506. In other embodiments, the user data is associated with a UE 1506 that shares data with the host 1502 without explicit human interaction. In step 1510, the host 1502 initiates a transmission carrying the user data towards the UE 1506. The host 1502 may initiate the transmission responsive to a request transmitted by the UE 1506. The request may be caused by human interaction with the UE 1506 or by operation of the client application executing on the UE 1506. The transmission may pass via the network node 1504, in accordance with the teachings of the embodiments described throughout this disclosure. Accordingly, in step 1512, the network node 1504 transmits to the UE 1506 the user data that was carried in the transmission that the host 1502 initiated, in accordance with the teachings of the embodiments described throughout this disclosure. In step 1514, the UE 1506 receives the user data carried in the transmission, which may be performed by a client application executed on the UE 1506 associated with the host application executed by the host 1502.

In some examples, the UE 1506 executes a client application which provides user data to the host 1502. The user data may be provided in reaction or response to the data received from the host 1502. Accordingly, in step 1516, the UE 1506 may provide user data, which may be performed by executing the client application. In providing the user data, the client application may further consider user input received from the user via an input/output interface of the UE 1506. Regardless of the specific manner in which the user data was provided, the UE 1506 initiates, in step 1518, transmission of the user data towards the host 1502 via the network node 1504. In step 1520, in accordance with the teachings of the embodiments described throughout this disclosure, the network node 1504 receives user data from the UE 1506 and initiates transmission of the received user data towards the host 1502. In step 1522, the host 1502 receives the user data carried in the transmission initiated by the UE 1506.

One or more of the various embodiments improve the performance of OTT services provided to the UE 1506 using the OTT connection 1550, in which the wireless connection 1570 forms the last segment. More precisely, embodiments described herein can provide a new service operation by which an NEF can request a UDM to remove authorization related to a service-specific parameter provisioning request, e.g., before a validity time for the authorization expires. Upon receiving such a request, the UDM can release and stop monitoring for updates pertaining to the resources related to the authorization This avoids waste of UDM resources (e.g., signaling, processing, storage, etc.) and facilitates more efficient operation of the 5GC. These increased efficiencies improve the delivery of OTT services via the 5GC, thereby increasing the value of such OTT services to both end users and service providers.

In an example scenario, factory status information may be collected and analyzed by the host 1502. As another example, the host 1502 may process audio and video data which may have been retrieved from a UE for use in creating maps. As another example, the host 1502 may collect and analyze real-time data to assist in controlling vehicle congestion (e.g., controlling traffic lights). As another example, the host 1502 may store surveillance video uploaded by a UE. As another example, the host 1502 may store or control access to media content such as video, audio, VR or AR which it can broadcast, multicast or unicast to UEs. As other examples, the host 1502 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1550 between the host 1502 and UE 1506, in response to variations in the measurement results. The measurement procedure and/or the network functionality for reconfiguring the OTT connection may be implemented in software and hardware of the host 1502 and/or UE 1506. In some embodiments, sensors (not shown) may be deployed in or in association with other devices through which the OTT connection 1550 passes; the sensors may participate in the measurement procedure by supplying values of the monitored quantities exemplified above, or supplying values of other physical quantities from which software may compute or estimate the monitored quantities. The reconfiguring of the OTT connection 1550 may include message format, retransmission settings, preferred routing etc.; the reconfiguring need not directly alter the operation of the network node 1504. Such procedures and functionalities may be known and practiced in the art. In certain embodiments, measurements may involve proprietary UE signaling that facilitates measurements of throughput, propagation times, latency and the like, by the host 1502. The measurements may be implemented in that software causes messages to be transmitted, in particular empty or ‘dummy’ messages, using the OTT connection 1550 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, etc., such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

1. A method in a Network Slice Admission Control Function (NSACF), the method comprising:
sending to a NSACF consumer, a Network Slice Admission Control (NSAC) data restoration notification message indicating a need for restoring NSAC data stored in the NSACF;
receiving from the NSACF consumer, a NSAC data restoration request message requesting for restoring the NSAC data; and
restoring the NSAC data based on the received NSAC data restoration request message.

2. The method of claim 1, wherein the NSAC data includes one or more of:
number of registered User Equipments (UEs),
number of established Protocol Data Unit (PDU) sessions,
list of UE IDs for registered UEs,
list of PDU session IDs per UE ID for established PDU sessions,
Network Slice information, and
Access Type.

3. The method of claim 1, wherein the NSAC data restoration notification message is sent when the NSACF detects an event for triggering NSAC data restoration or based on a local policy defined by an operator.

4. The method of claim 3, wherein the event for triggering NSAC data restoration comprises one or more of:
occurrence of corruption, loss or inconsistency in the NSAC data;
hardware and/or software fault; and
node restart of the NSACF.

5. The method of claim 1 further comprising:
determining a scope of NSAC data restoration; and
including one or more information elements defining the scope of NSAC data restoration in the NSAC data restoration notification message.

6. The method (300) of claim 5, wherein the information elements include one or more of:
a restoration identifier (ID) identifying NSAC data to be restored;
list of User Equipment (UE) IDs or UE ID ranges associated with the NSAC data to be restored;
Public Land Mobile Network (PLMN) ID associated with the NSAC data to be restored;
Data Network Name (DNN) associated with the NSAC data to be restored;
Network Slice information associated with the NSAC data to be restored;
Serving Area information associated with the NSAC data to be restored;
NSAC Data type associated with the NSAC data to be restored;
Access Type associated with the NSAC data to be restored;
Indicator of Evolved Packet System (EPS) interworking associated with the NSAC data to be restored;
list of PDU session IDs associated with the NSAC data to be restored;
a timer indicating a time reference for the NSAC data to be restored.

7-9. (canceled)

10. The method of claim 1, wherein sending the NSAC data restoration notification message to the NSACF consumer comprises:
sending the NSAC data restoration notification message to an endpoint of the NSACF consumer for receiving the NSAC data restoration notification message,
wherein the endpoint includes one or more of:
a predefined or default endpoint; and
an endpoint provided to the NSACF by the NSACF consumer.

11-12. (canceled)

13. The method of claim 1, further comprising:
querying a NF Repository Function (NRF) to obtain an endpoint of a NSACF consumer, that supports NSACF data restoration, for receiving the NSAC data restoration notification message;
wherein sending the NSAC data restoration notification message to the NSACF consumer comprises:
sending the NSAC data restoration notification message to the obtained endpoint of the NSACF consumer.

14. The method of claim 5, wherein the NSAC data restoration request message includes one or more information elements for the NSAC data restoration corresponding to the scope of NSAC data restoration defined in the NSAC data restoration notification message.

15-16. (canceled)

17. The method of claim 1, wherein the NSAC data restoration request message includes a restoration flag indicating that the NSAC data restoration request message is sent due to the NSAC data restoration.

18-19. (canceled)

20. A method in a Network Slice Admission Control Function (NSACF) consumer, the method comprising:
receiving, from a NSACF, a Network Slice Admission Control (NSAC) data restoration notification message indicating a need for restoring NSAC data stored in the NSACF; and
sending to the NSACF, a NSAC data restoration request message requesting for restoring the NSAC data.

21. The method of claim 20, wherein the NSAC data includes one or more of:
number of registered User Equipments (UEs),
number of established Protocol Data Unit (PDU) sessions,
list of UE IDs for registered UEs,
list of PDU session IDs per UE ID for established PDU sessions,
Network Slice information, and
Access Type; and/or
wherein the method further comprises:
determining a scope of NSAC data restoration based on the received NSAC data restoration notification message; and
including one or more information elements corresponding to the scope of NSAC data restoration in the NSAC data restoration request message.

22. (canceled)

23. The method of claim 21, wherein the information elements includes one or more of:
list of UE IDs associated with the NSAC data to be restored;
Network Slice information associated with the NSAC data to be restored;
Access Type associated with the NSAC data to be restored; and
list of PDU session IDs associated with the NSAC data to be restored.

24. The method of claim 20, wherein the method further comprises comprising:
including, in the NSAC data restoration request message, a restoration flag indicating that the NSAC data restoration request message is sent due to the NSAC data restoration; and/or
wherein the NSAC data restoration notification message includes a restoration ID identifying the NSAC data to be restored, and
wherein the method further comprises:
determining data in the NSACF consumer that is linked to the restoration ID included in the NSAC data restoration notification message; and
including one or more information elements indicating the determined data in the NSAC data restoration request message.

25. (canceled)

26. The method of claim 24, wherein the restoration ID is received in advance by the NSACF consumer from the NSACF, and linked to data in the NSACF consumer that is associated with the NSAC data identified by the restoration ID.

27. The method of claim 26, wherein the restoration ID is received in a response message to a NSAC request message of a NSAC procedure that has created the identified NSAC data.

28. The method of claim 20, further comprising: providing, to the NSACF, an endpoint of the NSACF consumer for receiving the NSAC data restoration notification message; and
wherein receiving the NSAC data restoration notification message comprises:
receiving the NSAC data restoration notification message at the provided endpoint.

29. The method of claim 28, wherein providing the endpoint comprises:
providing the endpoint of the NSACF consumer to the NSACF in a request message of a NSAC procedure.

30. The method of claim 20, further comprising:
registering, in a NF Repository Function (NRF), an endpoint of the NSACF consumer for receiving the NSAC data restoration notification message; and
wherein receiving the NSAC data restoration notification message comprises:
receiving the NSAC data restoration notification message at the registered endpoint.

31. A Network Slice Admission Control Function (NSACF) (600), comprising:
a processor; and
a memory coupled to the processor, the memory containing instructions executable by the processor, whereby the NSACF is operative to:
send, to a NSACF consumer, a Network Slice Admission Control (NSAC) data restoration notification message indicating a need for restoring NSAC data stored in the NSACF;
receive, from the NSACF consumer, a NSAC data restoration request message requesting for restoring the NSAC data; and
restore the NSAC data based on the received NSAC data restoration request message.

32-36. (canceled)
